(19) United States
(12) Patent Application Publication
(10) Pub. No.: US 2005/0168447 A1
(43) Pub. Date: Aug. 4, 2005

(54) Keypad and method for detecting the selection of one of a plurality of key inputs associated with a single key

(76) Inventors: Michael E. Caine, Needham, MA (US); Steven M. Herbst, Chester, NJ (US); Joshua D. Rubin, New York, NY (US); Richard A. Thrush, Garwood, NJ (US); Jason P. Wojack, Boynton Beach, FL (US)

Correspondence Address: MOTOROLA INC, 600 NORTH US HIGHWAY 45, ROOM AS437, LIBERTYVILLE, IL, 60048-5343, US

(21) Appl. No.: 10/769,258

(22) Filed: Jan. 30, 2004

(51) Int. Cl. G09G 5/00

(52) U.S. Cl. 345/169

(57) ABSTRACT

A keypad and method for detecting the selection of one of a plurality of key inputs associated with a single key is provided. The keypad includes one or more keys having a primary input selection and three or more secondary input selections. Each secondary input selection has a corresponding switch, where if only one of the switches is engaged when the key is actuated, the corresponding secondary input selection is indicated. If any combination of a plurality of switches are engaged, when the key is actuated, the primary input selection is indicated.

### FIELD OF THE INVENTION

The present invention relates generally to keypads and corresponding keys which detect one of a plurality of different input selections, and more particularly, to a keypad including one or more keys, each key having a switch associated with each of a corresponding one of multiple secondary input selections.

### BACKGROUND OF THE INVENTION

Keypads have long been used for the entry of data by users into various types of devices. During that period, keypads have taken many different shapes and forms. In many instances the nature of a keypad is largely dictated by the type of device, within which the keypad is incorporated. Various aspects associated with usage requirements, such as the type of data to be input, and or size requirements will often dictate at least some of the considerations, that factor into a keyboard's final form.

For many types of devices, there is a general trend for the overall size of the device, and consequently the size of the keypad to shrink in size. Furthermore, there is a trend for devices to have greater flexibility in the amount and the types of data that can be received by the device, via the keypad. In some instances, this is fueled by a convergence into a single device of functionality that was previously provided as parts of multiple devices. For example, device types that previously did not accommodate text entry are being redefined in a manner, which makes convenient text entry more important. However, in at least some of these instances the limited size, and correspondingly the number of keys can present an interesting challenge.

The assignment of multiple functions to individual keys has been previously used in an attempt to accommodate some of these issues. However associating multiple functions with a single key makes it important to have a manner in which the particular function which is desired can be identified. Some prior keypads have incorporated individual keys, which incorporate multiple switches, which can be independently engaged depending upon how the switch is actuated. In at least some instances, a particular function will be associated with a corresponding one of the switches. However, given some of the size constraints, it can be difficult to associate with a key, a number of switches equal to the number of desired functions.

In other instances, a particular function will be associated with a corresponding combination of the switches. This allows a number of functions to be defined, which exceeds the number of associated switches. At least one example of a key, which defines a unique actuation relative to the actuation of both individual switches and various combinations of switches is described in Riedl, U.S. Pat. No. 2,863,010.

In Riedl, '010, a single curved key surface, which extends over multiple switches, will actuate a different subset of the switches, depending upon where the key surface is engaged. Generally, the switches are located proximate the periphery of the key surface at different spaced apart points around the outer circumference of the key surface. By engaging the outer edge of the key surface proximate one of the switches, the corresponding switch can be closed without similarly closing the other switches. A pair of switches can be closed by engaging the key surface proximate the outer edge at a point between the pair of switches. Alternatively all of the switches can be closed by engaging the key surface proximate the center of the key surface, and depressing the entire key surface. However, as the geometries of a key become increasingly smaller, it can sometimes become difficult to accurately actuate any one particular subset of multiple switches, including where desirable to actuate all of the associated switches, substantially simultaneously.

The present inventors have recognized, that it would be beneficial to associate a function with each one of three of more switches, which are exclusively engaged, when the key is actuated, and a function with any combination of more than one of the switches, which are engaged, when the key is actuated. In this way, multiple functions can be associated with a particular key, which can be readily distinguished.

### SUMMARY OF THE INVENTION

The present invention provides a keypad having one or more keys, where each key is associated with a primary input selection and three or more secondary input selections. Each secondary input selection is associated with a corresponding one of a plurality of switches. A selection indicator, which is coupled to the plurality of switches, is adapted for detecting one of a primary input selection and a secondary input selection, when the key is actuated. One of the secondary input selections is indicated when only a corresponding one of the plurality of switches is engaged, when the key is actuated. A primary input selection is indicated when any combination of more than one of the plurality of switches are engaged, when the key is actuated.

In at least one embodiment, the keypad further includes a mode selector coupled to the selection indicator. The mode selector is adapted for distinguishing between a number entry mode and a text entry mode. In text entry mode, the primary input selections for the one or more keys substantially include numeric characters and the secondary input selections for the one or more keys substantially include non-numeric characters. When the keypad is in number entry mode, a secondary input selection, which is detected for at least one of the one or more keys, will be replaced by the corresponding primary input selection.

The present invention further provides a method for detecting the selection of one of a plurality of key inputs associated with a single key, where the key actuations include a primary input selection and three or more secondary input selections. The method includes monitoring the state of three or more switches, which are each associated with a corresponding one of the three or more secondary input selections. While monitoring the state of the three or more switches, a key actuation is detected. If only one of the switches is engaged when the key actuation is detected, the selection of the secondary input corresponding to the engaged switch is indicated. If any combination of a plurality of switches is engaged, when the key actuation is detected, the selection of the primary input is indicated.

These and other features, and advantages of this invention are evident from the following description of one or more preferred embodiments of this invention, with reference to the accompanying drawings.

### BRIEF DESCRIPTION OF THE DRAWINGS

FIG. 1 is a plan view of a keypad, in accordance with at least one embodiment of the present invention, illustrated as being incorporated as part of a portable electronic device;

FIG. 2 is an exemplary circuit schematic and corresponding layout of a key, in accordance with at least one embodiment, for use in the keypad illustrated in FIG. 1;

FIG. 3 is a block diagram of a keypad, in accordance with at least one embodiment of the present invention;

FIG. 4A is an exemplary plan view of a keypad, in accordance with at least a further embodiment of the present invention;

FIG. 4B is an exemplary plan view of a keypad, in accordance with at least a still further embodiment of the present invention;

FIG. 5 is a block diagram of a wireless communication device, within which a keypad in accordance with the present invention can be incorporated; and

FIG. 6 is a flow diagram of a method for detecting the selection of one of a plurality of key inputs associated with a single key.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

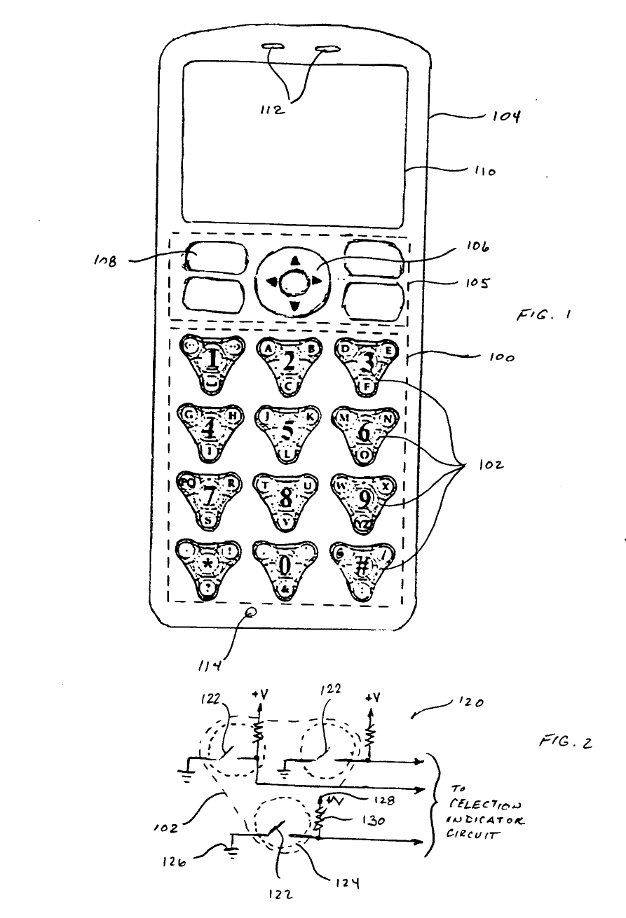

FIG. 1 illustrates a keypad 100, in accordance with at least one embodiment of the present invention. The keypad includes one or more keys 102, where each key 102 is associated with a primary input selection and three or more secondary input selections. For example, in the illustrated embodiment, each key has a primary input selection which is associated with a numeric entry, corresponding to a telephone numeric keypad, including numeric characters 0-9 and special characters * and #. Each key additionally has multiple secondary selections which are associated with text entry including alphabetic characters A-Z, as well as some additional special characters. In the illustrated embodiment, the keys are generally triangular in shape having three vertices. Each vertex is associated with a corresponding secondary input selection.

The keypad 100 is incorporated as part of an electronic device 104, such as a wireless communication device. In addition to keypad 100, the electronic device includes additional keys 105, one of which can be associated with the navigation 106 of a cursor being presented on a display 110, and various other keys which are associated with other operational selections. In at least one embodiment, the additional keys 108 located proximate to a display 110 could be used to select a function, which is identified on the nearby display 110, and which may change depending upon the operational context of the device 104. Still further, the electronic device 104 can include speaker ports 112 and a microphone port 114, which can be used to convey audio signals between the device 104 and the user of the device.

In at least one embodiment, the additional keys 105 includes more standard keys. For example, the additional keys 108 can include a single switch, which is associated with a single type of actuation. Similarly, the navigation key 106 could be in the form of any well known navigation type key. In at least some instances, the navigation key 106 will have a center post upon which the contact surface pivots, which limits the ability of oppositely positioned switches to be simultaneously engaged.

FIG. 2 is an exemplary circuit schematic and corresponding layout 120 of a key 102, in accordance with at least one embodiment, for use in conjunction with the keypad 100, illustrated in FIG. 1. The key 102 is generally triangular in shape. At each vertex of the key 102, the key includes a corresponding switch 122. The switches 122 can take one of many different forms, but generally would be engaged, when the corresponding one of the vertices is depressed. For example, the switch can be mechanical, electrical or optical. Still further, the switch could detect a make/break condition or could alternatively sense in varying degrees the amount of an applied force. One skilled in the art will readily appreciate that the switch could take any one of various different forms without departing from the teachings of the present invention. By applying a force to the key 102 proximate one of the vertices, only one of the switches 122 may be engaged, when the key 102 is actuated. If the force is applied to the key 102 closer to the center of the key 102, more than one of the switches 122 may be engaged, when the key 102 is actuated.

In at least one embodiment, the switch 122 could include a popple 124, which has a center that becomes mechanically displaced and makes an electrical connection, with a conductor located beneath the popple 124 when an external force is applied. When the external force is removed, the center of the popple 124 is biased back towards an undisplaced position, and the electrical connection is broken. In the illustrated embodiment, one end of each switch 122 is coupled to a ground potential 126, which is conveyed to a selection indicator circuit, when the key 102 is actuated, if the switch 122 is engaged. The other end of each of the switches 122 is biased toward a positive reference voltage 128, via a pull-up resister 130.

Locating the switch at a vertex gives the user a discrete location to engage, if and when it is desired to indicate a secondary input selection, which assists in engaging only a single switch. As the size of the button decreases, however, engaging a particular combination of a plurality of switches can be a little more problematic. This is due in part to the limited amount of surface area, and the corresponding distance between the points where a force would need to applied to engage a particular combination. Defining a primary input selection as corresponding to any combination, where a plurality of switches are engaged and/or substantially simultaneously engaged when the key is actuated, helps to alleviate this problem. In effect, this has the effect of expanding the target area, and increasing the types of forces, which will register as a primary input selection. As a result, a user does not need to be as precise in the type of force that is applied, when attempting to select a primary input selection, which in turn allows users greater flexibility in entering user selections, as well as increases the speed with which the selections can be entered. Still further, the greater flexibility in registering a primary input selection more readily facilitates input using fingers (or thumbs) from both hands, where the force applied is more likely to engage the key from opposite sides and at a direction angled toward one of the sides.

FIG. 3 illustrates a block diagram 140 of a keypad, in accordance with at least one embodiment of the present invention. The keypad includes one or more keys 102, which incorporate both the primary and the secondary input selections, as discussed above. The one or more keys 102 are coupled to a selection indicator 142, which is adapted to receive and interpret the signals from the separate switches 122 (shown in FIG. 2), and to identify which one of a primary or secondary input selection, for the one or more keys 102 was selected by the user. In at least some embodiments, the selection indicator will include a processor 144, which is coupled to the switches 122. The processor 144 can execute one or more sets of prestored instructions 146, which are adapted to enable the signals received from the switches 102 to be interpreted, and the appropriate selection to be identified.

The one or more sets of prestored instructions 146 can be stored in a memory element 148, which is coupled to the processor 144, or in at least an alternative embodiment of the present invention, can be stored in a memory element, which is integrated as part of the processor 144. The memory element 148 can take the form of one or more different forms of storage including both volatile and non-volatile memory, such as one or more types of semi-conductor memories (i.e. ROM, EPROM, RAM or EEPROM, etc.). Still further, the different types of storage could include auxiliary storage, such as a disk drive, which includes either a fixed or removable media including magnetic disks or optical discs.

Still further the processor could incorporate discrete logic elements and/or other circuit elements, which are arranged to produce the necessary control signals for identifying and/or distinguishing between the different possible input selections.

In at least some instances, the primary input selection will be associated with a numeric entry, for example to be used in connection with entering a telephone number. In such instances, the secondary input selections could be associated with textual entry, associated with the entry of alphabetic and some special characters, which could be used in entering words and phrases.

Allowing any combination to be used to detect a primary input selection has increased the flexibility, and in at least some instances, the ease with which a primary input selection can be made. In some instance, it may be possible to provide even greater flexibility. For example, if the device was operating in a mode, where a numeric selection was expected, a secondary input selection associated with a particular key, where only a single switch was engaged, could be interpreted by the selection indicator 142 as a primary input selection. This might be particularly useful, when a telephone number was being entered, or the device was operating as a calculator, where a numeric calculation was being performed. In at least some instances, such an operating mode could be identified via a mode selector 150, which could be coupled to the selection indicator 142.

In some embodiments, the operating mode associated with the mode selector 150 could be identified through a menu selection or the actuation of another key, such as one of the additional keys 105, illustrated in FIG. 1. In other instances, the state of the mode selector 150 could be context sensitive, relative to the operation of the device 104, within which the keypad 100 is incorporated. Alternatively, it may be possible, where appropriate, to convert a primary input selection into a secondary input selection, for example, where text entry of alphabetic characters may be expected. However in such an instance, selecting the particular secondary input selection may be a little more problematic given the one to many relationship of primary input selections to secondary input selections relative to a particular key. However, where a varying degree of engagement or selection for each of the switches can be determined, it may be possible to make a decision concerning, which one of the secondary input selections, that a particular primary input selection should be converted into, based upon the degree of engagement. For example, a varying degree of force may be able to be detected relative to the one or more engaged switches. In this instance, the particular secondary input selection that is selected may correspond to the switch, which is detecting the highest amount of force.

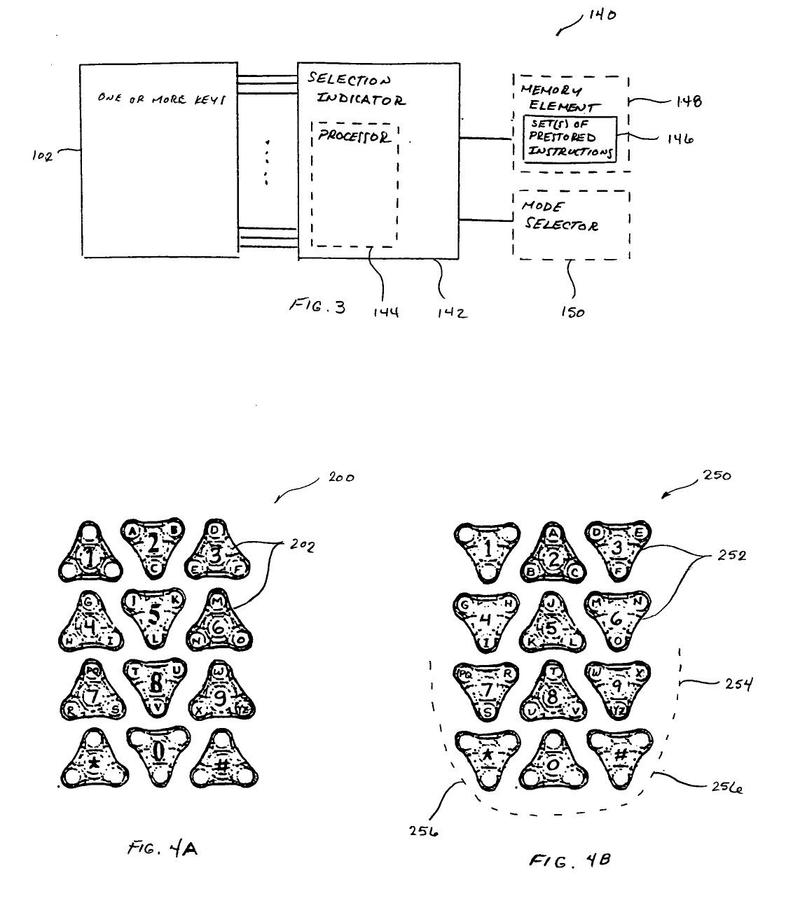

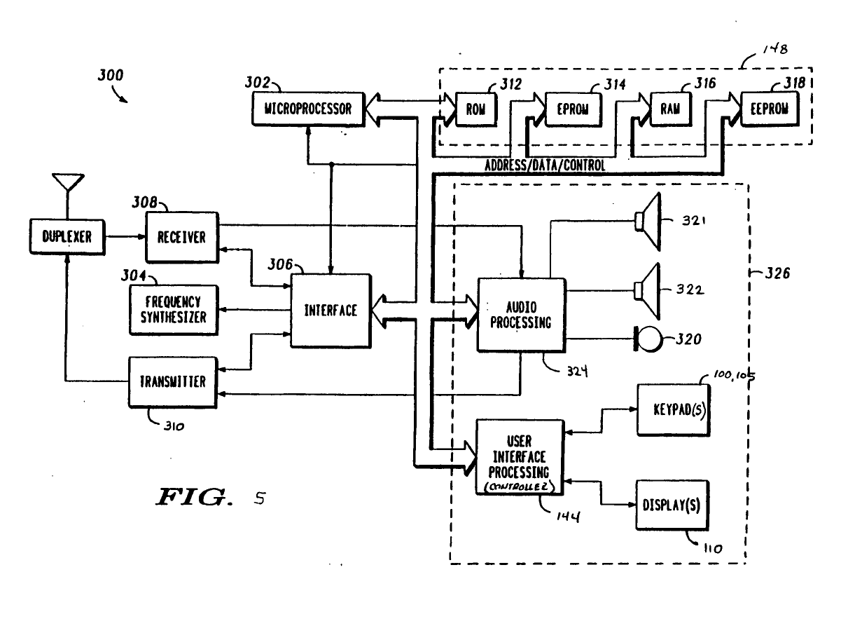

FIG. 4A illustrates an exemplary plan view of a keypad 200, in accordance with at least a further embodiment of the present invention. The keypad 200 includes multiple keys 202 arranged in multiple rows and columns. As noted previously, in at least some instances, the size of a keyboard can be an important consideration. In the present embodiment, the orientation of the alternative keys 202 are reversed relative to the orientation of adjacent keys 202 located in the same row. In this way, the spacing between keys 202 can be reduced, which enables the overall size of the keypad 200 to similarly be reduced.

FIG. 4B illustrates an exemplary plan view of a keypad 250, in accordance with at least a still further embodiment of the present invention. The keypad 250, illustrated in FIG. 4B, differs from the keypad 200, illustrated in FIG. 4A, in that the orientation of each of the multiple keys 250 is reversed (i.e. rotated approximately 180 degrees). In other words, as opposed to pointing upward, the triangular shaped keys located in the outside columns point downward. The keys located in the center column, alternatively point upward. Such an orientation enables an external contour 254 of a device incorporating the keypad 250 to have a more closely conforming taper 256, proximate the bottom row keys in the outside columns of the keypad 250.

In the present embodiments, each key generally includes a numeric or special character, associated with a typical numeric keypad, which is centrally identified on the key and corresponds to a primary input selection. Each key can additionally include multiple alphabetic and special characters, which are identified proximate the vertices of each of the keys, which correspond to a plurality of secondary input selections. In at least a couple of instances, relative to the present embodiment, a particular secondary input selection may be associated with more than one character. At least one example includes both a ‘P’ and a ‘Q’, which are associated with one of the vertices and secondary input selections of the ‘7’-key. Another example includes the both a ‘Y’ and a ‘Z’, which are associated with one of the vertices and secondary input selections of the ‘9’-key. In these instances, a first selection of the corresponding secondary input may register a first one of the two associated characters. If the other one of the two associated characters is desired, a repeated sequential selection of the same secondary input will cause the selected character to change or cycle between the multiple characters associated with the same secondary input selection.

If the detection of two sequential entries of characters from the same set of cycled multiple characters is desired, which is associated with a secondary input selection having more than one character, the user may wait for the character cycling to reset before entry of the next character. Once the character cycling associated with the secondary input selection has reset, entry of the next character, which is from the same set of cycled multiple characters, would be possible through the single or repeated sequential selection of the same secondary input. At least one potential example of a condition where character cycling may be defined to reset includes a predetermined time, such as 1.5 seconds, having elapsed before the same secondary input is sequentially selected. A further potential example includes an advancement of the input cursor, before the same secondary input is selected again.

As an alternative to the sequential cycling, the selection of a particular predefined function key either simultaneously or immediately prior to the selection of the secondary input could be used for differentiating between a plurality of characters associated with a particular secondary input selection.

The ability to change or cycle between different characters associated with the same secondary input selection of the same key, enables a still larger number of characters to be associated with a key without increasing the number of secondary input selections and corresponding switches. Still further, this allows four characters to be mapped to a key of a keypad, which has a substantially triangular shape and three corresponding secondary input selections, and which accommodate characters mappings that more closely match a standard telephone keypad.

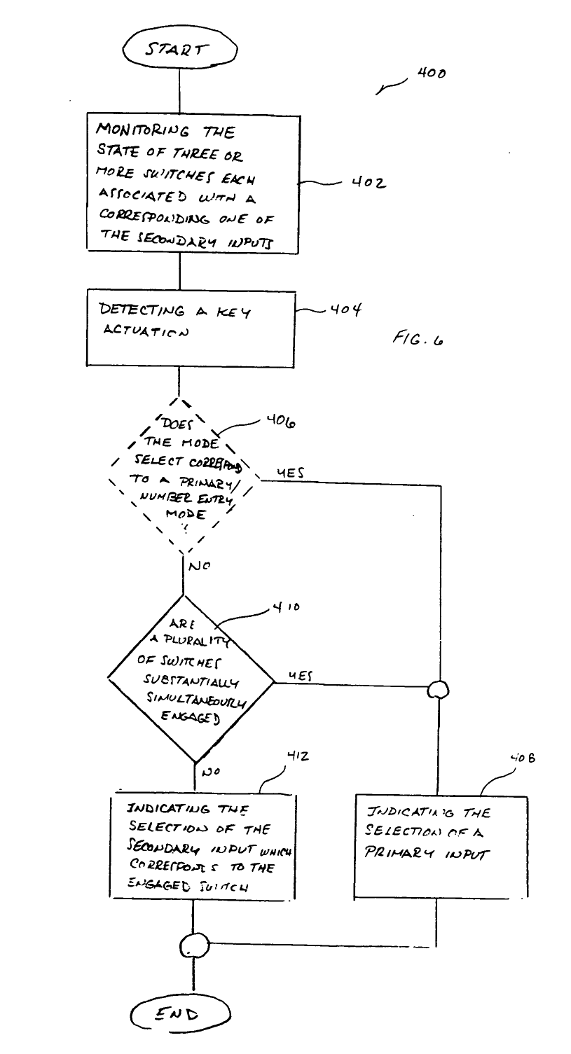

FIG. 5 illustrates a block diagram of a wireless communication device 300, like a cellular telephone, within which the keypad of the present invention can be incorporated. Generally, the wireless communication device communicates information via radio frequency signals. In the wireless communication device 300, the particular radio frequency is determined by the microprocessor 302. The particular radio frequency is conveyed to the frequency synthesizer 304 via the interface circuitry 306. Data signals received by the receiver 308 are decoded and coupled to the microprocessor 302 by the interface circuitry 306, and data signals to be transmitted by the transmitter 310 are generated by the microprocessor 302 and formatted by the interface circuitry 306 before being transmitted by the transmitter 310. Operational status of the transmitter 310 and the receiver 308 is enabled or disabled by the interface circuitry 306.

In at least one embodiment, the microprocessor 302, an audio processor 324, and a user interface processor 144 perform many of the processing functions under the control of program instructions stored in a memory section 148. Together, the microprocessor 302, the audio processor 324, and the user interface processor 144 can include one or more microprocessors, one or more of which may include a digital signal processor (DSP). The memory element or memory section 148 includes one or more forms of volatile and/or non-volatile memory including conventional ROM 312, EPROM 314, RAM 316, or EEPROM 318. As noted previously, one skilled in the art will readily recognize that other types of memory are possible.

Identifying features of the wireless communication device are typically stored in EEPROM 318 (which may also be stored in the microprocessor in an on-board EEPROM, if available) and can include the number assignment (NAM) required for operation in a conventional cellular system and/or the base identification (BID) required for operation with a cordless base. Additionally stored in the memory section 148 are prestored instructions for identifying which keypad input selection was indicated. In many cases prestored and/or downloaded audio files for later playback may be additionally be stored in the memory element 148, such as ringer tones, sounds generated by the programming of the user interface, multi-media and/or other types of files with audio related data. These files can be stored in either open standard, proprietary, and/or other types of formats.

The microphone 320 and the pair of speakers 321, 322 are controlled by the audio processor or audio processing circuitry 324, which forms part of a user interface circuit 326. The user interface circuit 326 additionally includes the user interface processor or user interface processing circuitry 144, and further incorporates the selection indicator 142 illustrated in FIG. 3, which manages the operation of the keypad(s) 100 and 105 and the display(s) 110. It is further envisioned that additional keypad operation could be included as part of a touch sensitive display.

While the present invention has generally been described in association with a wireless communication device, like a cell phone, radiotelephone, or a cordless telephone, one skilled in the art will readily recognize that the invention is suitable for use with other types of devices. At least a couple of additional examples of other types of devices, where the use of the present invention would be suitable include paging devices, personal digital assistants, portable computers, remote control units, audio players (such as an MP3 player), and any device incorporating a keypad or the like.

FIG. 6 illustrates a flow diagram of method 400 for detecting the selection of one of a plurality of key inputs associated with a single key. The method includes monitoring 402 the state of three or more switches, each of which is associated with a corresponding one of a plurality of secondary input selections. A key actuation is then detected 404.

Optionally, a determination 406 is then made as to whether a mode, which corresponds to the primary input selections, is selected. If such a mode is selected, then a primary input selection corresponding to the actuated key is indicated 408. If no such mode has been selected, a determination is then made as to whether any combination of a plurality of switches are engaged and/or substantially simultaneously engaged, when the key actuation is detected 410. If a plurality of switches being engaged and/or substantially simultaneously engaged is detected, then a primary input selection corresponding to the actuated key is similarly indicated 408. If only one of the switches is engaged when the key actuation is detected 410, a secondary input which corresponds to the switch is indicated 412 as being selected.

As noted above, in some circumstances, the optionally detected mode switch could alternatively detect a mode corresponding to the secondary input selections. Still further, where multiple characters are associated with the same secondary input selection, the method could additionally detect the repeated selection of the corresponding same secondary input selection, which would cause the secondary input selection which was indicated to cycle between multiple associated characters.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A keypad comprising:
one or more keys, each key being associated with a primary input selection and three or more secondary input selections, wherein each secondary input selection is associated with a corresponding one of a plurality of switches; and
a selection indicator coupled to the plurality of switches and adapted for detecting one of a primary input selection and a secondary input selection, when the key is actuated, wherein one of the secondary input selections is indicated when only a corresponding one of the plurality of switches is engaged, when the key is actuated, and a primary input selection is indicated when any combination of more than one of the plurality of switches are engaged, when the key is actuated.

2. A keypad in accordance with claim 1 wherein the selection indicator is adapted for indicating a primary input selection when the combination of more than one of the plurality of switches are engaged, substantially simultaneously, when the key is actuated.

3. A keypad in accordance with claim 1 wherein said selection indicator includes a processor coupled to the plurality of switches of the one or more keys.

4. A keypad in accordance with claim 3 wherein said keypad further comprises a memory element for storing one or more set of prestored instructions used by the processor in detecting the selection of a primary input and a secondary input.

5. A keypad in accordance with claim 1 wherein the one or more primary input selections associated with each of the one or more keys substantially include numeric characters.

6. A keypad in accordance with claim 1 wherein the primary input selections are primarily associated with number entry.

7. A keypad in accordance with claim 1 wherein the three or more secondary input selections associated with each of the one or more keys substantially include non-numeric characters.

8. A keypad in accordance with claim 1 wherein the secondary input selections are primarily associated with text entry.

9. A keypad in accordance with claim 1 further comprising a mode selector coupled to the selection indicator, said mode selector adapted for distinguishing between a number entry mode and a text entry mode, wherein when in text entry mode the primary input selections for the one or more keys substantially include numeric characters and the secondary input selections for the one or more keys substantially include non-numeric characters, and wherein when in number entry mode a secondary input selection detected for at least one of the one or more keys will be replaced by the corresponding primary input.

10. A keypad in accordance with claim 1 wherein one or more of the secondary input selections for at least one or more of the one or more keys is associated with multiple different input selections, wherein detecting the selection of the secondary input selection associated with multiple different input selections selects a first one of the associated multiple secondary input selections, and wherein detection of repeated sequential selections of the secondary input selection associated with multiple different input selections cycles the original input selection between the associated multiple secondary input selections.

11. A keypad in accordance with claim 1 wherein each of the one or more keys includes a contact surface having a plurality of comers, wherein each of the plurality of switches corresponding to each of the secondary input selections are located proximate a corresponding one of the comers of the contact surface.

12. A keypad in accordance with claim 11 wherein the contact surface for at least some of the one or more keys is a triangular shape, having three comers.

13. A keypad in accordance with claim 12 wherein the orientations in one or more directions of adjacent ones of the one or more keys are not aligned.

14. A keypad in accordance with claim 13 wherein adjacent ones of the one or more keys having a triangular shape are oriented in opposite directions.

15. A keypad in accordance with claim 1 wherein said keypad is incorporated as part of a portable electronic device.

16. A keypad in accordance with claim 15 wherein said portable electronic device is a wireless communication device.

17. A keypad in accordance with claim 16 wherein said wireless communication device is a cellular telephone.

18. An electronic device with a keypad comprising:
a key associated with a primary character having
a first contact associated with a first secondary character,
a second contact associated with a second secondary character, and
a third contact associated with a third secondary character;
wherein closure of only one of the first contact, the second contact and the third contact during a predetermined time period enters the associated secondary character into the electronic device; and
wherein closure of two or more of the first contact, the second contact and the third contact during the predetermined time period enters the primary character into the electronic device.

19. A method of detecting the selection of one of a plurality of key inputs associated with a single key, where said key actuations include a primary input selection and three or more secondary input selections, said method comprising:
monitoring the state of three or more switches each associated with a corresponding one of the three or more secondary input selections;
detecting a key actuation;
if only one of the switches is engaged when the key actuation is detected, indicating the selection of the secondary input corresponding to the engaged switch; and
if any combination of a plurality of switches is engaged, when the key actuation is detected, indicating the selection of the primary input.

20. A method in accordance with claim 19 wherein the determination of any combination of a plurality of switches being engaged, when the key actuation is detected, includes a determination that any combination of a plurality of switches is engaged, substantially simultaneously, when the key actuation is detected.

21. A method in accordance with claim 19 wherein the primary input selections are substantially associated with numeric characters and the secondary input selections are substantially associated with non-numeric characters, said method further comprising detecting a mode selection, which distinguishes between a number entry mode and a text entry mode, and replacing secondary input selection indication with a primary input selection indication, when in number entry mode.

22. A method in accordance with claim 19 wherein one or more of the secondary input selections for at least one or more of the one or more keys is associated with multiple different input selections, said method further comprising detecting the selection of the secondary input selection associated with multiple different input selections, selecting a first one of the associated multiple secondary input selections, detecting repeated sequential selections of the secondary input selection associated with multiple different input selections, and in response to repeated sequential selections, cycling the original input selection between the associated multiple secondary input selections.
